(19) United States
(12) Patent Application Publication
(10) Pub. No.: US 2008/0137081 A1
(43) Pub. Date: Jun. 12, 2008

(54) METHOD AND SYSTEM FOR RAMAN SPECTROSCOPY WITH ARBITRARY SAMPLE CELL

(75) Inventor: Naoki MURAKAMI, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/951,574

(22) Filed: Dec. 6, 2007

(30) Foreign Application Priority Data
Dec. 8, 2006 (JP) 2006-331607
Sep. 19, 2007 (JP) 2007-241782

(51) Int. Cl. G01J 3/44

(52) U.S. Cl. 356/301

(57) ABSTRACT

In a Raman spectroscopic system: a sample cell in which a sample is filled or through which the sample flows down, where the sample has fluidity and contains one or more materials being to be measured, and having an electrophoretic feature or being conditioned in advance so as to have an electrophoretic feature; a Raman scattering device which has a sample-contact surface, is arranged so that the sample is in contact with the sample-contact surface, and outputs Raman-scattered light when the sample-contact surface is illuminated with measurement light; an optical system which illuminates with the measurement light the sample in contact with the sample-contact surface; a voltage application unit which is provided with the sample cell and applies an electric voltage to the sample so as to bring the one or more materials close to the sample-contact surface by electrophoresis; and a detection unit which detects the Raman-scattered light.

### BACKGROUND OF THE INVENTION

1. Field of the Invention

The present invention relates to a method and a system for Raman spectroscopy, in which a material is illuminated with monochromatic light, and scattered light produced by the illumination is separated into spectral components to obtain a Raman spectrum for identification and the like of the material. Specifically, in the method and system for Raman spectroscopy, Raman-scattered light is detected by placing a sample containing a material which is to be measured and is in contact with a Raman scattering device, which produces the Raman-scattered light in response to illumination with measurement light (light for measurement).

2. Description of the Related Art

The Raman spectroscopic analysis is an analytical technique for use in material identification and the like. In the Raman spectroscopic analysis, a material is illuminated with monochromatic light, Raman-scattered light obtained by the illumination is separated into spectral components, and the spectrum of the Raman-scattered light (Raman spectrum) is analyzed. Although the Raman-scattered light is weak, it is known that the intensity of the Raman-scattered light is increased by illuminating the sample with measurement light while placing the sample in contact with a metal body (especially a metal body with a surface having a fine structure of protrusions and recessions). This phenomenon is called the surface-enhanced Raman scattering (SERS) effect.

Generally, when the Raman spectroscopic analysis is performed by using a Raman scattering device utilizing the SERS effect, it is necessary to perform the analysis under the condition that the material which is to be measured and is contained in the sample be located on or near the surface of the Raman scattering device, and it is particularly preferable to perform the analysis under the condition that the material which is to be measured and is contained in the sample be absorbed at the surface of the Raman scattering device. This is because the SERS effect is diminishing as the distance from the Raman scattering device to the material to be measured increases.

For example, in the field of the surface plasmon sensor, a ligand which can be specifically bonded to a material contained in a sample and to be measured is fixed in advance to a surface of a metal film at which surface plasmon resonance occurs, and the material contained in the sample and to be measured is sensed by causing the specific bond to the ligand fixed to the surface of the metal film. However, according to such a technique, it takes a long time until the material which is to be measured and is specifically bonded to the ligand fixed to the surface of the metal film reaches a sufficient amount, so that it is difficult to speedily perform the measurement. In addition, since the materials which can be specifically bonded to ligands are limited, the materials which can be measured by using the above technique are limited.

Further, the electrophoresis is known as a technique for separating a plurality of materials to be measured (such as proteins, peptides, amino acids, and the like) contained in a sample when microanalysis of the sample containing the materials to be measured is performed. The capillary electrophoresis is most preferable among various electrophoretic techniques, since the amount of the sample needed by the capillary electrophoresis is small, and the influence of convection of the sample caused by Joule heat can be ignored.

Japanese Unexamined Patent Publication No. 09 (1997)-281076 (hereinafter referred to as JPP09 (1997)-281076) and International Patent Publication No. WO01/25757 disclose devices which can concurrently perform sample separation by using the capillary electrophoresis and the Raman spectroscopic analysis of the separated sample.

Specifically, in the device disclosed in JPP09 (1997)-281076, a SERS-active micro-electrode having a fiberlike shape is inserted into a capillary in which electrophoresis of the materials to be measured occurs, and the separated materials to be measured can be collected into a layered form around the SERS-active micro-electrode by the capillary electrophoresis. Thus, the device disclosed in JPP09 (1997)-281076 can perform Raman spectroscopic analysis of the separated materials to be measured by illuminating the SERS-active micro-electrode with measurement light. (See Paragraph 0008 and FIG. 1 of JPP09 (1997)-281076.)

The device disclosed International Patent Publication No. WO01/25757 can precipitate the materials which are to be measured and are separated by the capillary electrophoresis, at different positions on a SERS-active substrate, and perform Raman spectroscopic analysis of the precipitated materials to be measured. (See claim 7 and FIG. 4 of International Patent Publication No. WO 01/25757.)

The devices disclosed in JPP09 (1997)-281076 and International Patent Publication No. WO01/25757 can collect the materials to be measured on a Raman scattering device utilizing the SERS effect.

However, in the device disclosed in JPP09 (1997)-281076, it is necessary to shape the Raman scattering device into the fiberlike form which enables the insertion of the Raman scattering device into the capillary for the electrophoresis, so that the process of shaping the Raman scattering device is very complicated.

In the device disclosed in International Patent Publication No. WO01/25757, it is necessary to precipitate the materials which are to be measured and are separated by the capillary electrophoresis, on the Raman scattering device utilizing the SERS effect, so that complex operations and much time are necessary for achieving precipitation of each material to be measured. In addition, since it is further necessary to precipitate the materials which are to be measured and are separated by the capillary electrophoresis, at different positions on a SERS-active substrate, the required time and complexity of the operations for precipitation of the materials to be measured increases with the number of the materials to be measured.

Further, although the sample cells inmost of the conventional Raman spectroscopic systems do not have a capillary form, neither JPP09 (1997)-281076 nor International Patent Publication No. WO 01/25757 teaches a manner of collecting on a Raman scattering device materials which are to be measured and are contained in a noncapillary sample cell.

### SUMMARY OF THE INVENTION

The present invention has been developed in view of the above circumstances.

The first object of the present invention is to provide a Raman spectroscopic system which has a simple construction and can easily and speedily perform high-sensitivity Raman spectroscopic analysis by effectively bringing a material which is to be measured and is contained in a sample cell to or close to a surface of a Raman scattering device.

The second object of the present invention is to provide a Raman spectroscopic method which performs Raman spectroscopic analysis by using the above Raman spectroscopic system.

(I) In order to accomplish the first object, according to the first aspect of the present invention, there is provided a Raman spectroscopic system comprising: a sample cell in which a sample is filled or through which the sample flows down, where the sample has fluidity and contains one or more materials being to be measured, and having an electrophoretic feature or being conditioned in advance so as to have an electrophoretic feature; a Raman scattering device which has a sample-contact surface, and outputs Raman-scattered light when the sample-contact surface is illuminated with measurement light, where the Raman scattering device is arranged in such a manner that the sample is in contact with the sample-contact surface; an optical system which illuminates with the measurement light the sample in contact with the sample-contact surface; a voltage application unit which is provided with the sample cell and applies an electric voltage to the sample so as to bring the one or more materials close to the sample-contact surface by electrophoresis; and a detection unit which detects the Raman-scattered light.

In the above description of the Raman spectroscopic system, the “electrophoretic feature” is the feature of being electrically charged and able to be moved by an electric field. The sample cell may be fully or partially filled with the sample, or the sample may flow down through the entire or partial cross section of the sample cell. For example, claim 1, FIG. 1, and some other portions of Japanese Unexamined Patent Publication No. 09 (1997)-304339 (corresponding to claim 1, FIG. 13, and some other portions of U.S. Pat. No. 5,917,608) disclose a surface plasmon sensor in which a material to be measured is brought close to a metal film by electrophoresis realized by applying an electric voltage to a sample in a noncapillary sample cell in order to detect the material to be measured, where the material to be measured is contained in the sample, and the surface plasmon occurs on the metal film, although JPP09 (1997)-304339 does not disclose a Raman spectroscopic system.

Preferably, the Raman spectroscopic system according to the first aspect of the present invention may further have one or any possible combination of the following additional features (i) to (vi).

(i) The Raman scattering device comprises a first electrode, a dielectric body formed above the first electrode, and a metal body being arranged above the dielectric body and in contact with the sample and causing surface-enhanced Raman scattering, and the voltage application unit is realized by the first electrode and a second electrode (as a counter electrode) arranged opposite to the Raman scattering device in such a manner that at least a portion of the sample exists between the counter electrode and the Raman scattering device.

(ii) The Raman scattering device comprises a metal body being arranged in contact with the sample, causing surface-enhanced Raman scattering, and behaving as a first electrode, and the voltage application unit is realized by the first electrode and a second electrode (as a counter electrode) arranged opposite to the Raman scattering device in such a manner that at least a portion of the sample exists between the counter electrode and the Raman scattering device.

In the Raman spectroscopic system having the feature (i) or (ii), the counter electrode may be arranged either right opposite or diagonally opposite to the Raman scattering device. The position of the counter electrode is not specifically limited as long as at least a portion of the sample exists between the counter electrode and the Raman scattering device. The counter electrode may or may not be located in the sample, and may be attached to the sample cell.

(iii) In the Raman spectroscopic system having each of the features (i) and (ii), the metal body has a structure of protrusions and recessions which is finer than the wavelength of the measurement light. In this specification, the expression “a structure of protrusions and recessions which is finer than the wavelength of the measurement light” means that the average pitch of the structure of protrusions and recessions is smaller than the wavelength of the measurement light. The metal may or may not exist in the recessed portions of the above structure.

(iv) In the Raman spectroscopic system having each of the features (i) and (ii), the metal body contains as at least one main component at least one of the metals Au, Ag, Cu, Al, Pt, Ni, and Ti and alloys of two or more of the metals Au, Ag, Cu, Al, Pt, Ni, and Ti. In this specification, the main component is defined as a component the content of which is 90% or higher.

(v) In the Raman spectroscopic system having each of the features (i) and (ii), the sample cell has a capillarylike form with first and second ends, where the first end is in contact with the sample-contact surface, and the second end is in contact with the counter electrode.

(vi) In the Raman spectroscopic system having each of the features (i) and (ii), the sample-contact surface is surface modified so that the one or more materials can be ionic bonded and/or covalently bonded to the surface-modified sample-contact surface.

(II) In order to accomplish the second object, according to the second aspect of the present invention, there is provided a Raman spectroscopic method comprising the steps of: (a) preparing a sample having fluidity and containing one or more materials which are to be measured, and have an electrophoretic feature or are conditioned in advance so as to have an electrophoretic feature; (b) placing the sample in contact with a sample-contact surface of a Raman scattering device, which outputs Raman-scattered light when the sample-contact surface is illuminated with measurement light; (c) applying an electric voltage to the sample while maintaining the sample in contact with the sample-contact surface so as to bring the one or more materials close to the sample-contact surface by electrophoresis; and (d) illuminating the sample with the measurement light when the one or more materials exist near the sample-contact surface, and detecting the Raman-scattered light.

In order to accomplish the second object, according to the third aspect of the present invention, there is provided a Raman spectroscopic method comprising the steps of: (a) preparing a sample having fluidity and containing one or more materials which are to be measured and have an amphoteric feature; (b) conditioning the hydrogen ion concentration of the sample so that the one or more materials are positively or negatively charged; (c) placing the sample in contact with a sample-contact surface of a Raman scattering device, which outputs Raman-scattered light when the sample-contact surface is illuminated with measurement light; (d) applying an electric voltage to the sample while maintaining the sample in contact with the sample-contact surface so as to bring the one or more materials close to the sample-contact surface by electrophoresis; and (e) illuminating the sample with the measurement light when the one or more materials exist near the sample-contact surface, and detecting the Raman-scattered light.

Preferably, the Raman spectroscopic method according to each of the second and third aspects of the present invention may further have one or any possible combination of the following additional features (vii) to (ix).

(vii) The sample-contact surface is surface modified so that the one or more materials brought close to the surface-modified sample-contact surface can be covalently bonded or ionic bonded to the surface-modified sample-contact surface, and the Raman-scattered light is detected in step (d) in the Raman spectroscopic method according to the second aspect of the present invention or in step (e) in the Raman spectroscopic method according to the third aspect of the present invention after the one or more materials brought close to the surface-modified sample-contact surface are covalently bonded or ionic bonded to the surface-modified sample-contact surface.

(viii) In the Raman spectroscopic method having the feature (vii), the Raman-scattered light is detected after the application of the electric voltage to the sample is stopped after the one or more materials brought close to the surface-modified sample-contact surface are covalently bonded or ionic bonded to the surface-modified sample-contact surface.

(ix) In the Raman spectroscopic method having the feature (viii), the Raman-scattered light is detected after impurities included in the sample are eliminated after the one or more materials brought close to the surface-modified sample-contact surface are covalently bonded or ionic bonded to the surface-modified sample-contact surface. The impurities included in the sample include constituents of the sample in contact with the sample-contact surface other than the one or more materials covalently bonded or ionic bonded to the surface modification of the sample-contact surface.

(III) The present invention has the following advantages.

The Raman spectroscopic system according to the first aspect of the present invention comprises the voltage application unit, which applies the electric voltage to the sample in the sample cell so as to bring the one or more materials which are to be measured and are contained in the sample cell, close to the sample-contact surface of the Raman scattering device by electrophoresis. In addition, according to the Raman spectroscopic methods according to the second and third aspects of the present invention, the electric voltage is applied to the sample in the sample cell (in step (c) in the Raman spectroscopic method according to the second aspect or in step (d) in the Raman spectroscopic method according to the third aspect) so as to bring the one or more materials which are to be measured and are contained in the sample cell, close to the sample-contact surface of the Raman scattering device by electrophoresis. Since the sample has fluidity and the one or more materials contained in the sample have an electrophoretic feature or are conditioned in advance so as to have an electrophoretic feature, the one or more materials to be measured can be brought close to the sample-contact surface of the Raman scattering device by electrophoresis.

In the Raman spectroscopic system according to the first aspect of the present invention and the Raman spectroscopic methods according to the second and third aspects of the present invention, the one or more materials to be measured can be brought close to the sample-contact surface of the Raman scattering device regardlessly of the shape of the sample cell. Therefore, reliable analysis can be performed in a situation in which the amounts of the materials to be measured existing on the sample-contact surface or in the vicinity of the sample-contact surface are sufficient, and the surface-enhanced Raman scattering (SERS) effect effectively occurs at the sample-contact surface. Therefore, it is possible to stably perform highly sensitive analysis.

Further, the Raman spectroscopic system according to the first aspect of the present invention has a simple construction, and can easily and speedily perform the analysis.

Furthermore, in the Raman spectroscopic system according to the first aspect of the present invention and the Raman spectroscopic methods according to the second and third aspects of the present invention, when necessary, it is possible to adjust the amounts of the materials which are to be measured and are brought to or close to the sample-contact surface, and other characteristics of the Raman spectroscopy, by adjusting the applied voltage.

Moreover, in the case where the sample-contact surface of the Raman scattering device is surface modified so that the materials to be measured can be bonded to the surface-modified sample-contact surface, the bringing of the materials to be measured close to the sample-contact surface enhances the bonding of the materials to be measured to the Raman scattering device, and increases the amounts of the materials to be measured which are absorbed at the sample-contact surface. In this case, the Raman-scattered light can be detected after portions of the sample which can produce noise during measurement are eliminated. Therefore, it is possible to stably perform highly sensitive analysis.

### DESCRIPTION OF THE DRAWINGS

FIG. 1 is a diagram schematically illustrating a Raman spectroscopic system according to a first embodiment of the present invention.

FIGS. 2A, 2B, and 2C are diagrams schematically illustrating preferable examples of the Raman scattering device.

FIGS. 3A, 3B, and 3C are diagrams schematically illustrating other preferable examples of the Raman scattering device.

FIGS. 4A, 4B, and 4C are diagrams schematically illustrating representative stages of a process for producing the Raman scattering device illustrated in FIG. 2C.

FIG. 5 is a diagram schematically illustrating a variation of the Raman spectroscopic system according to the first embodiment.

FIG. 6 is a diagram schematically illustrating a Raman spectroscopic system according to a second embodiment of the present invention.

### DESCRIPTION OF PREFERRED EMBODIMENTS

Preferred embodiments of the present invention are explained in detail below with reference to drawings. In the drawings, equivalent elements and constituents are indicated by the same reference numbers even in drawings for different embodiments or examples, and descriptions of the equivalent elements or constituents are not repeated in the following explanations unless necessary.

### 1. First Embodiment

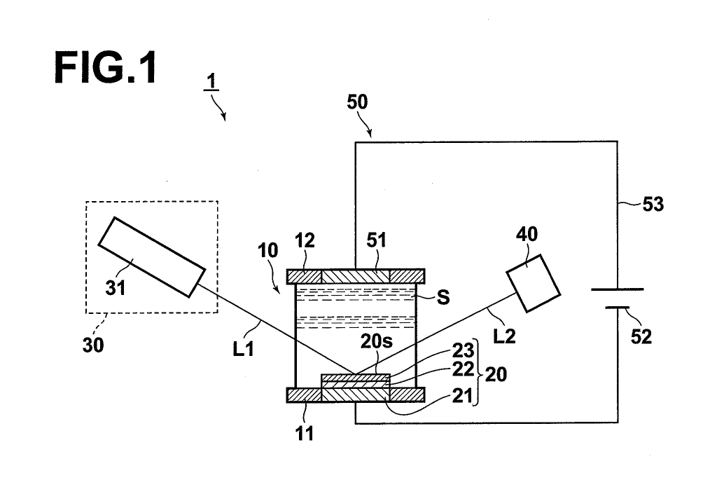

The construction of the Raman spectroscopic system according to the first embodiment of the present invention and a Raman spectroscopic method using the Raman spectroscopic system according to the first embodiment are explained below with reference to FIGS. 1 to 5.

### 1.1 Raman Spectroscopic System

FIG. 1 is a diagram schematically illustrating the Raman spectroscopic system according to the first embodiment. As illustrated in FIG. 1, the Raman spectroscopic system 1 according to the first embodiment comprises a sample cell 10, a Raman scattering device 20, an illumination optical system 30 for measurement light, and a detection unit 40. The sample cell 10 contains a sample S. The Raman scattering device 20 has a platelike shape, and is arranged in such a manner that the sample S in the sample cell 10 is in contact with the Raman scattering device 20. The illumination optical system 30 illuminates the sample-contact surface 20s of the Raman scattering device 20 with measurement light L1. The Raman scattering device 20 outputs Raman-scattered light when a sample-contact surface 20s of the Raman scattering device 20 is illuminated with measurement light L1. The detection unit 40 detects the Raman-scattered light.

Specifically, the illumination optical system 30 is an optical system which illuminates the sample-contact surface 20s with measurement light L1, which is monochromatic light having a specific wavelength. The illumination optical system 30 comprises a light source 31, which emits, for example, laser light. Although not shown, the illumination optical system 30 may further comprise a light-guiding optical system for guiding light emitted from the light source 31, when necessary. The light-guiding optical system is constituted by, for example, one or more mirrors, one or more lenses, and the like.

The detection unit 40 is a spectroscopic detector which receives detection light L2 from the Raman scattering device 20, separates the detection light L2 into spectral components, detects the Raman-scattered light from the detection light L2, and obtains a Raman spectrum. When the sample-contact surface 20s of the Raman scattering device 20 is illuminated with the measurement light L1, reflected light and scattered light are produced at the sample-contact surface 20s of the Raman scattering device 20, and the detection light L2 includes both of the reflected light and the scattered light.

The sample cell 10 is a boxlike cell formed of insulating material, and has, for example, a rectangular shape. The sample cell 10 has a bottom plate 11 and a top plate 12, which are arranged apart from and opposite to each other. The denotations of the bottom plate 11 and the top plate 12 in the example of FIG. 1 are determined merely for convenience, and the top/bottom direction of the sample cell 10 may be appropriately designed according to need.

The sample S contains one or more materials to be measured, which are, for example, one or more of proteins, peptides, and amino acids. A voltage application unit 50 is provided with the sample cell 10. The voltage application unit 50 applies an electric voltage to the sample S so as to bring the one or more materials to be measured close to the sample-contact surface 20s of the Raman scattering device 20 by electrophoresis.

The Raman scattering device 20 is a device constituted by an electrode 21, a dielectric body 22 formed on the electrode 21, and a metal body 23 formed on the dielectric body 22. The metal body 23 can cause surface-enhanced Raman scattering (SERS) when the sample S in contact with a surface (realizing the sample-contact surface 20s) of the metal body 23 is illuminated. The Raman scattering device 20 is fixed to the sample cell 10 in such a manner that the electrode 21 is fit in the bottom plate 11 and the sample S in the sample cell 10 is in contact with the sample-contact surface 20s of the metal body 23. The manner of fixing the Raman scattering device 20 to the sample cell 10 can be appropriately designed according to need.

A counter electrode 51 is fit in the top plate 12 of the sample cell 10 in such a manner that the counter electrode 51 is arranged right opposite to the Raman scattering device 20, and at least a portion of the sample S exists between the counter electrode 51 and the Raman scattering device 20. In addition, a power source 52 and wirings 53 are arranged outside the sample cell 10 in order to apply the electric voltage between the electrode 21 (of the Raman scattering device 20) and the counter electrode 51. The electrode 21, the counter electrode 51, the power source 52, and the wirings 53 constitute the voltage application unit 50.

It is preferable that the metal body 23 of the Raman scattering device 20 have a structure of protrusions and recessions which is finer than the wavelength of the measurement light L1. In this case, the Raman-scattered light can be enhanced.

### 1.2 Raman Scattering Device

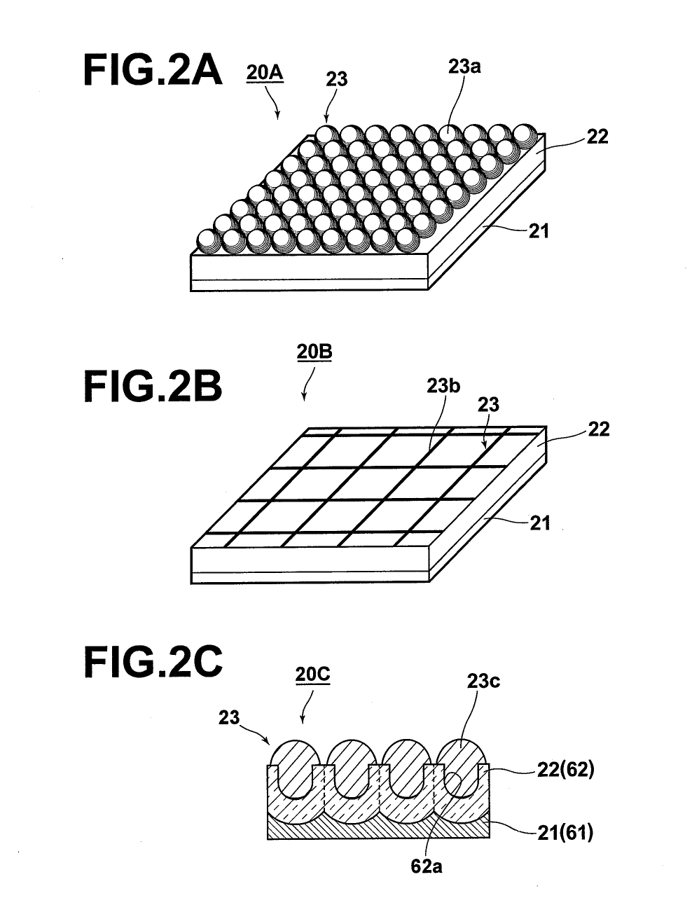

Hereinbelow, preferable examples of the Raman scattering device which can be used as the Raman scattering device 20 in the Raman spectroscopic system 1 illustrated in FIG. 1 are explained with reference to FIGS. 2A to 2C, 3A to 3C, and 4A to 4C.

FIG. 2A is a perspective view of a first example 20A of the Raman scattering device. The Raman scattering device 20A is formed by fixing an array 23 of a number of metal particles 23a onto a lamination of a planar electrode 21 and a planar dielectric body 22. That is, the electrode 21, the dielectric body 22, and the metal body 23 illustrated in FIG. 1 are respectively realized by the planar electrode 21, the planar dielectric body 22, and the array 23 of the metal particles 23a in this example.

Although the arrangement of the metal particles 23a can be appropriately designed according to need, it is preferable that the metal particles 23a be substantially regularly arranged. In the example of FIG. 2A, the respective metal particles 23a realize the protrusions of the metal body 23, and the average diameter of the metal particles 23a and the average pitch of the array of the metal particles 23a are designed to be smaller than the wavelength of the measurement light L1.

FIG. 2B is a perspective view of a second example 20B of the Raman scattering device. The Raman scattering device 20B is produced by forming a metal grid layer 23 (realized by a grid of thin metal wire 23b) on a lamination of a planar electrode 21 and a planar dielectric body 22. That is, the electrode 21, the dielectric body 22, and the metal body 23 illustrated in FIG. 1 are respectively realized by the planar electrode 21, the planar dielectric body 22, and the metal grid layer 23 in this example.

Although the arrangement of the metal wire 23b can be appropriately designed according to need, it is preferable that the metal wire 23b be substantially regularly arranged. In the example of FIG. 2B, the average width of the thin metal wire 23b and the average pitch of the grid of thin metal wire 23b are designed to be smaller than the wavelength of the measurement light L1.

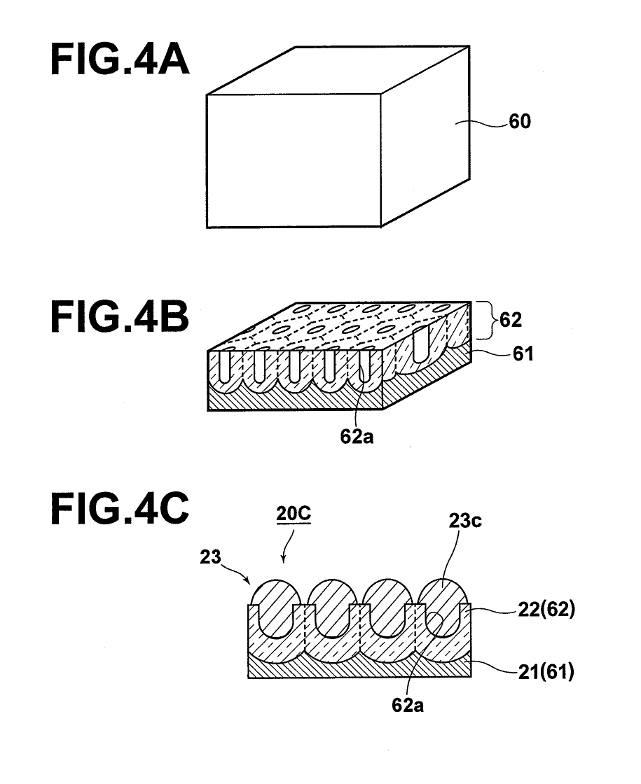

FIG. 2C is a cross-sectional view of a third example 20C of the Raman scattering device. The Raman scattering device 20C can be produced by anodically oxidizing the top portion of a parent metal body (a metal body to be anodized) 60 (of, for example, aluminum) so as to produce a metal oxide body 62 (of, for example, Al₂O₃), and growing, by plating or the like, a metal grain 23c in each of micropores 62a of the metal oxide body 62 which are produced during the anodic oxidation. The representative stages of this process for production of the Raman scattering device 20C are illustrated in FIGS. 4A, 4B, and 4C, which are perspective views of the first and second stages of the process, and FIG. 4C is a cross-sectional view of the final stage of the process.

As illustrated in FIG. 4C, the metal grain 23c is grown in each of the micropores 62a until the top portion of the metal grain 23c protrudes from the top of the metal oxide body 62 and has a mushroomlike shape. The process of FIGS. 4A to 4C is disclosed in Japanese Unexamined Patent Publication No. 2005-172569. Since the distribution of the micropores 62a produced by the above process is substantially regular, the distribution of the top portions of the metal grains 23c grown in the micropores 62a also becomes substantially regular.

Thus, the electrode 21, the dielectric body 22, and the metal body 23 illustrated in FIG. 1 are respectively realized by the non-oxidized portion 21 (61) of the parent metal body 60, the metal oxide body 22 (62), and the array of the metal grains 23c in the example of FIG. 2C. As illustrated in FIG. 2C, each of the top portions of the metal 23c has a globular shape. Therefore, the upper side of the Raman scattering device 20C appears to be an array of metal particles arranged on the dielectric body 22. In the example of FIG. 2C, the average diameter of the metal grains 23c and the average pitch of the array of the metal grains 23c are designed to be smaller than the wavelength of the measurement light L1.

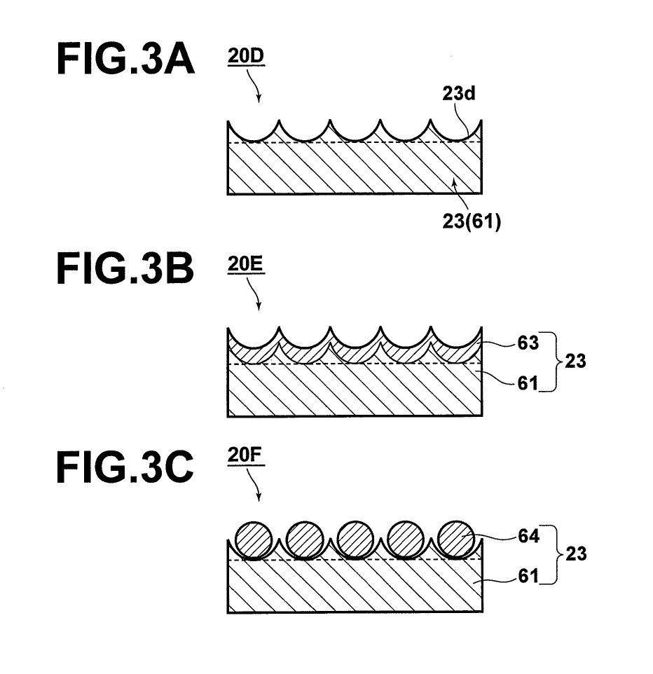

Although the examples of the Raman scattering device explained above are constituted by the electrode 21, the dielectric body 22, and the metal body 23, alternatively, the Raman scattering device 20 may be realized by only the metal body 23 as the fourth to sixth examples of the Raman scattering device, which are illustrated in FIGS. 3A to 3C and explained below.

FIG. 3A is a perspective view of a fourth example 20D of the Raman scattering device. The Raman scattering device 20D is formed by anodically oxidizing the top portion of a parent metal body 60 as in the first stage of the process illustrated in FIG. 4A, and removing the anodically oxidized portion 62 from the parent metal body 60 so as to leave only the non-oxidized portion 23 (61) of the parent metal body 60. This process is disclosed in Japanese Unexamined Patent Publication No. 2006-250924 (corresponding to U.S. Patent Application No. 20060181701 A1). As illustrated in FIG. 3A, the non-oxidized portion 23 (61) of the parent metal body 60 realizing the Raman scattering device 20D has dimples (recessions) 23D over the upper surface.

FIG. 3B is a perspective view of a fifth example 20E of the Raman scattering device. The Raman scattering device 20E is formed by forming a metal layer 63 over the upper surface of the Raman scattering device 20D illustrated in FIG. 3A. This process is also disclosed in Japanese Unexamined Patent Publication No. 2006-250924 and the corresponding U.S. Patent Application No. 20060181701 A1.

FIG. 3C is a perspective view of a sixth example 20F of the Raman scattering device. The Raman scattering device 20F is formed by annealing the metal layer 63 of the Raman scattering device 20E so as to granulate the metal layer 63, and produce metal particles 64 on the non-oxidized portion 23 (61) of the parent metal body 60. This process is disclosed in Japanese Unexamined Patent Application No. 2006-198009.

Since the metal body 23 realized in each of the first to sixth examples 20A to 20F of the Raman scattering device has a structure with substantially regular protrusions and recessions, the SERS effect is obtained with small variations over the entire upper surface of the Raman scattering device. Therefore, the first to sixth examples 20A to 20F of the Raman scattering device are preferable.

Further alternatively, the metal body 23 may be realized by a metal layer the surface of which is roughened. The surface can be roughened by an electrochemical technique utilizing oxidation-reduction reaction. Furthermore, the Raman scattering device 20 may be any other device producing the SERS effect. For example, H. Wang et al., “Nanosphere Arrays with Controlled Sub-10-nm Gaps as Surface-Enhanced Raman Spectroscopy Substrates,” Journal of the American Chemical Society, Vol. 127, Issue 43 (2005), pp. 14992-14993 disclose a Raman scattering device which is formed by arraying Au particles on an ITO substrate, where the Au particles are surface modified with CTAB (cetyltrimethylammonium bromide). In addition, Japanese Unexamined Patent Publication No. 2005-233637 discloses a Raman scattering device in which a gold-nanorod thin film is formed on a substrate.

### 1.3 Operations of First Embodiment

In the Raman spectroscopic system 1 according to the first embodiment, the sample S has fluidity, and the one or more materials contained in the sample S have an electrophoretic feature or are conditioned in advance so as to have an electrophoretic feature. The sample S is filled in or flows through the sample cell 10 for measurement. The state of the sample S is not specifically limited as long as the sample S has liquidity. For example, the sample S may be liquid, gel, or sol.

Then, an electric voltage is applied to the sample S while the sample S is maintained in contact with the sample-contact surface 20s of the Raman scattering device 20, so that the one or more materials to be measured are brought close to the sample-contact surface 20s by electrophoresis. The sample S is illuminated with the measurement light L1 when the one or more materials to be measured exist near the sample-contact surface. Thus, the Raman-scattered light is outputted from the Raman scattering device 20, and can be detected.

In the case where the one or more materials to be measured are one or more materials having an amphoteric feature such as proteins, peptides, and amino acids, it is possible to condition the hydrogen ion concentration (pH) of the sample S so that the one or more materials to be measured are positively or negatively charged. In this case, the one or more materials to be measured can be brought close to the sample-contact surface 20s of the Raman scattering device 20 by conditioning the hydrogen ion concentration (pH) of the sample S so as to negatively charge the one or more materials to be measured when the electrode 21 is the anode, and positively charge the one or more materials to be measured when the electrode 21 is the cathode.

The Raman spectroscopic system 1 according to the first embodiment can perform measurement of a plurality of materials to be measured, when the sample S contains the plurality of materials to be measured. In this case, it is possible to separate the plurality of materials by utilizing the difference in the electrophoretic velocity, and perform measurement in the order in which the plurality of materials to be measured reach the vicinity of the sample-contact surface 20s. It is preferable to remove the Raman scattering device 20 from the Raman spectroscopic system 1 and clean the sample-contact surface 20s every time measurement of one of the materials to be measured is completed.

It is preferable that the sample-contact surface 20s be surface modified so that one or more materials to be measured can be ionic bonded or covalently bonded to the surface-modified sample-contact surface. In this case, the one or more materials to be measured can be strongly absorbed at the sample-contact surface 20s, and the concentrations of the one or more materials to be measured absorbed at the sample-contact surface 20s increase.

In the case where the one or more materials to be measured are one or more of proteins, peptides, and amino acids, a first type of surface modification to which the one or more materials to be measured can be ionic bonded can be realized with one or more chemical groups (as one or more surface-modification groups) charged oppositely to the one or more materials to be measured. Such chemical groups may be one or more of the carboxyl group, the sulfonic acid group, the phosphoric acid group, the amino group, the quaternary ammonium group, the imidazole group, the guanidium group, and derivatives of these chemical groups. The sample-contact surface 20s may be surface modified with two or more of the above chemical groups.

In the case where the one or more materials to be measured are one or more of proteins, peptides, and amino acids, a second type of surface modification to which the one or more materials to be measured can be covalently bonded can be realized with one or more of the chemical groups (as one or more surface-modification groups) selected from the reactive ester groups (including N-hydroxysuccinimidyl ester), the carbodiimid group, the 1-hydroxybenzotriazole group, the hydrazide group, the thiol group, the reactive disulfide groups, the maleimide group, the aldehyde group, the epoxide group, the (meth)acrylate group, the hydroxyl group, the isocyanate group, the isothiocyanate group, and derivatives of these chemical groups. The sample-contact surface 20s may be surface modified with two or more of the above chemical groups. Among the above chemical groups, the reactive ester groups, the hydrazide group, the thiol group, and the reactive disulfide groups are particularly preferable.

The term “reactive” in the above paragraphs means reactiveness with the one or more materials to be measured.

It is particularly preferable to apply to the sample-contact surface 20s both of the first type of surface modification (to which the one or more materials to be measured can be ionic bonded) and the second type of surface modification (to which the one or more materials to be measured can be covalently bonded). In this case, it is possible to apply the first and second types of surface modification either concurrently or successively. The positions of the first and second types of surface modification on the sample-contact surface 20s are not specifically limited. The first and second types of surface modification may be bonded to each other, and may independently bonded to the sample-contact surface 20s.

It is further preferable to first apply the first type of surface modification (to which the one or more materials to be measured can be ionic bonded) to the sample-contact surface 20s, and then activate the first type of surface modification by applying the second type of surface modification (to which the one or more materials to be measured can be covalently bonded). In this case, the first type of surface modification and the second types of surface modification are located close to each other on the sample-contact surface 20s. Therefore, each ion or molecule of each of the one or more materials to be measured can be strongly absorbed at the sample-contact surface 20s by both of the ionic bonding and the covalent bonding.

For example, it is preferable to first introduce the carboxyl group (to which the one or more materials to be measured can be ionic bonded), and then realize the activation by deriving from the carboxyl group a functional group (for example, a reactive ester group, the hydrazide group, the thiol group, or a reactive disulfide group) which can be covalently bonded to the one or more materials to be measured.

For example, the following materials (1) to (3) have both of a surface-modification group which can be ion bonded to the one or more materials to be measured and a surface-modification group which can be covalently bonded to the one or more materials to be measured.

(1) Molecules which can form a self-assembled film including 4,4′-dithiodibutylic acid (DDA), 10-carboxy-1-decanthiol, 11-amino-1-undecanthiol, 7-carboxy-1-heptanthiol, 16-mercaptohexadecanoic acid, and 11-11′-thiodiundecanoic acid.

(2) Hydrogels of agarose, dextran, carrageenans, alginic acid, starches, celluloses, and the like, and derivatives of these materials (for example, carboxymethyl derivatives).

(3) Water-swellable organic polymers such as polyvinyl alcohol, polyacrylic acid, polyacrylamide, and polyethylenglycol.

For example, in the case where a material to be measured is adenine, 4,4′-dithiodibutylic acid (DDA), carboxymethyl dextran (CMD), and the like are preferable surface-modification materials having both of a surface-modification group which can be ion bonded to adenine and a surface-modification group which can be covalently bonded to adenine.

In the case where the sample-contact surface 20s is surface modified so that one or more materials to be measured can be ionic bonded or covalently bonded to the surface-modified sample-contact surface 20s, the one or more materials to be measured are absorbed at the surface-modified sample-contact surface 20s. Therefore, even when the application of the electric voltage to the sample S is stopped after the one or more materials to be measured are ionic bonded or covalently bonded to the surface-modified sample-contact surface 20s, and then the Raman-scattered light is detected, it is possible to stably perform high-sensitivity measurement.

In addition, when the application of the electric voltage to the sample S can be stopped as above, it is possible to detect the Raman-scattered light after the fluidal portion of the sample S, which are not bonded to the surface-modified sample-contact surface 20s and can produce noise, is removed.

If the measurement (i.e., the detection of the Raman-scattered light) is performed in a situation in which the fluidal portion of the sample S is not removed from the Raman spectroscopic system 1, peaks of Raman-scattered light from the solvent of the sample S and other materials which are not to be measured can overlap the Raman-scattered light from the one or more materials to be measured when the Raman-scattered light from the one or more materials to be measured is detected. That is, the Raman-scattered light from the solvent of the sample S and other materials which are not to be measured is noise, and lowers the signal-to-noise ratio. Therefore, the high-sensitivity measurement can be performed more stably in the situation in which the fluidal portion of the sample S is removed from the Raman spectroscopic system 1 after the one or more materials to be measured are bonded to the sample-contact surface 20s, than in the situation in which the fluidal portion of the sample S is not removed from the Raman spectroscopic system 1.

After the one or more materials to be measured are bonded to the sample-contact surface 20s, the fluidal portion of the sample S may be removed either before or after the stop of the application of the electric voltage.

The manner of detection of the Raman-scattered light after the removal of the fluidal portion of the sample S is not specifically limited. For example, the Raman-scattered light may be detected either after simply removing the fluidal portion of the sample S, or after cleaning the sample cell 10 and the sample-contact surface 20s one or more times after the removal of the fluidal portion of the sample S.

The sample cell 10 and the sample-contact surface 20s can be cleaned by using ultrasonic waves, or a solvent which is Raman inactive and nonreactive with the one or more materials to be measured. The ultrasonic cleaning should be carefully performed so as not to cut the bonds between the one or more materials to be measured and the surface-modified sample-contact surface 20s. The solvent which is Raman inactive and nonreactive with the one or more materials to be measured is, for example, pure water. The term “Raman inactive” means that the peaks of the Raman-scattered light from the solvent do not overlap the peaks of the Raman-scattered light from the one or more materials to be measured.

After the cleaning of the sample cell 10 and the sample-contact surface 20s, the Raman-scattered light may be detected either with the empty sample cell 10 or with the sample cell 10 filled with a solvent which is Raman inactive and nonreactive with the one or more materials to be measured.

### 1.4 Advantages of First Embodiment

As explained before, the Raman spectroscopic system 1 according to the first embodiment comprises the voltage application unit 50, which applies the electric voltage to the sample S so as to bring the one or more materials to be measured (contained in the sample S) close to the sample-contact surface 20s of the Raman scattering device 20 by electrophoresis. Since the sample S has fluidity and the one or more materials contained in the sample have an electrophoretic feature or are conditioned in advance so as to have an electrophoretic feature, the one or more materials to be measured can be brought close to the sample-contact surface 20s of the Raman scattering device 20 by electrophoresis.

In the Raman spectroscopic system 1, the one or more materials to be measured can be brought close to the sample-contact surface 20s of the Raman scattering device 20 regardlessly of the shape of the sample cell 10. Therefore, reliable analysis can be performed in the situation in which the amounts of the one or more materials to be measured existing on the sample-contact surface 20s or in the vicinity of the sample-contact surface 20s are sufficient. In addition, the surface-enhanced Raman scattering (SERS) effect effectively occurs. Therefore, it is possible to stably perform highly sensitive analysis.

Further, in the Raman spectroscopic system 1, when necessary, it is possible to adjust the amounts of the materials to be measured which are brought to or close to the sample-contact surface 20s, and other characteristics of the Raman spectroscopic system 1, by adjusting the applied voltage.

Furthermore, in the case where the sample-contact surface 20s of the Raman scattering device 20 is surface modified so that the one or more materials to be measured can be bonded to the surface-modified sample-contact surface, the bringing of the materials to be measured close to the sample-contact surface enhances the bonding of the materials to be measured to the Raman scattering device 20, and increases the amounts of the one or more materials to be measured which are absorbed at the sample-contact surface 20s. Therefore, it is possible to stably perform highly sensitive analysis.

Although the devices disclosed in JPP09 (1997)-281076 and International Patent Publication No. WO 01/25757 require the shaping of the Raman scattering device into the fiberlike form which enables the insertion of the Raman scattering device into the capillary for the electrophoresis as explained before in the “Description of the Related Art,” the Raman spectroscopic system 1 according to the first embodiment does not require the shaping of the Raman scattering device.

In addition, the devices disclosed in JPP09 (1997)-281076 and International Patent Publication No. WO 01/25757 perform the sample separation by using the conventional capillary electrophoresis. In order to realize the electrophoresis in the devices disclosed in JPP09 (1997)-281076 and International Patent Publication No. WO 01/25757, it is necessary to prepare two containers filled with a buffer solution, immerse the opposite ends of the capillary in the buffer solution in the two containers in order to fill the capillary with the buffer solution, and then inject the sample S into the capillary from one end. Thereafter, an electric voltage is applied between the two containers. On the other hand, the Raman spectroscopic system 1 according to the first embodiment does not need the containers filled with a buffer solution, and the Raman spectroscopic system 1 is required only to fill the sample cell 10 with the sample S or simply make the sample S flow down through the sample cell 10, and apply the electric voltage to the sample S.

The Raman spectroscopic system 1 according to the first embodiment has a simple construction, and can easily and speedily perform the analysis.

### 1.5 Variation of First Embodiment

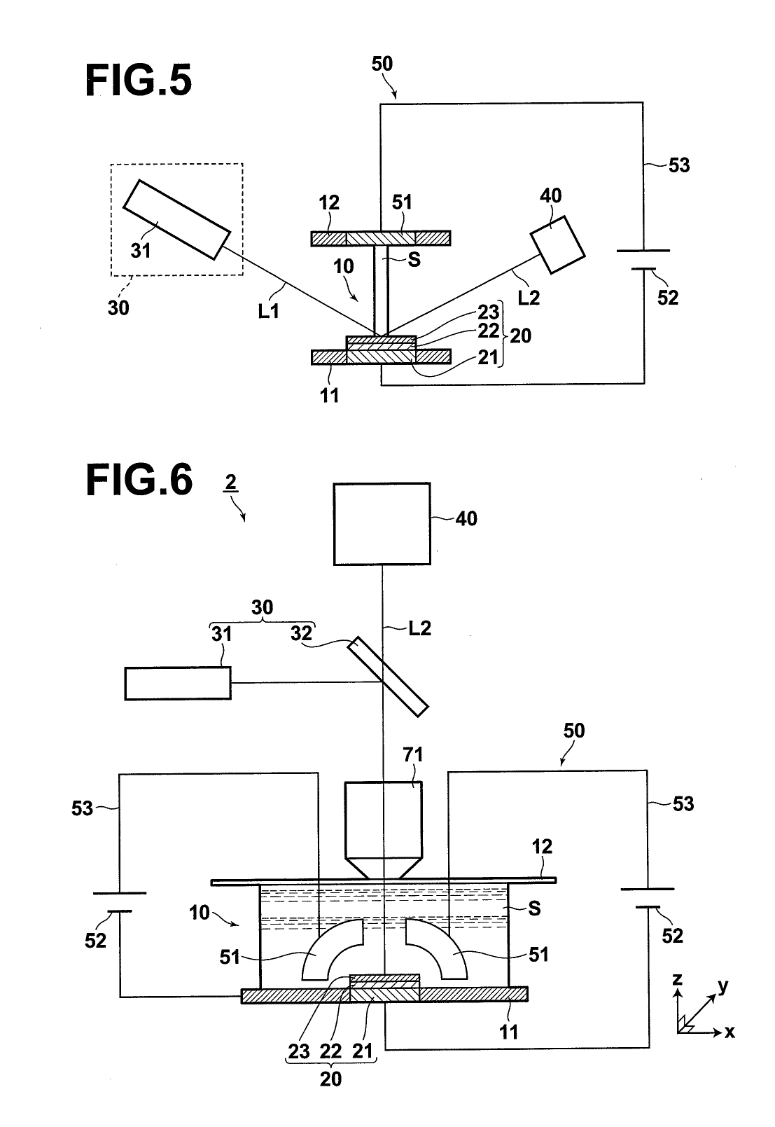

Although the sample cell 10 in the Raman spectroscopic system 1 according to the first embodiment has a boxlike shape, alternatively, the sample cell may have a capillarylike shape as illustrated in FIG. 5, which is a diagram schematically illustrating a variation of the Raman spectroscopic system according to the first embodiment. In this variation, one end of the capillarylike sample cell 10 is in contact with the sample-contact surface 20s of the Raman scattering device 20, and the other end of the capillarylike sample cell 10 is in contact with the counter electrode 51. The other portions of the Raman spectroscopic system illustrated in FIG. 5 are similar to the Raman spectroscopic system 1 illustrated in FIG. 1, and the Raman scattering devices 20A to 20F illustrated in FIGS. 2A to 2C and 3A to 3C can be used as the Raman scattering device 20 in the Raman spectroscopic system of FIG. 5.

The Raman spectroscopic system of FIG. 5 can perform the measurement in a similar manner to the Raman spectroscopic system of FIG. 1, so that the Raman spectroscopic system of FIG. 5 has similar advantages to the Raman spectroscopic system of FIG. 1. In addition, the amount of the sample needed in the Raman spectroscopic system of FIG. 5 is very small. Therefore, it is possible to ignore the influence of the convection of the sample S caused by the Joule heat.

### 2. Second Embodiment

The construction of the Raman spectroscopic system according to the second embodiment of the present invention and a Raman spectroscopic method using the Raman spectroscopic system according to the second embodiment are explained below with reference to FIG. 6, which is a diagram schematically illustrating the Raman spectroscopic system according to the second embodiment. In FIG. 6, equivalent elements and constituents are indicated by the same reference numbers as the first embodiment.

The Raman spectroscopic system 2 according to the second embodiment is a microscopic Raman spectroscopic system. As illustrated in FIG. 6, similar to the first embodiment, the Raman spectroscopic system 2 according to the second embodiment comprises a sample cell 10, a Raman scattering device 20, an illumination optical system 30 for measurement light, and a detection unit 40. The sample cell 10 contains a sample S. The Raman scattering device 20 has a platelike shape, and is arranged in such a manner that the sample S in the sample cell 10 is in contact with the Raman scattering device 20. The illumination optical system 30 illuminates the sample-contact surface 20s of the Raman scattering device 20 with measurement light L1. The Raman scattering device 20 outputs Raman-scattered light when the sample-contact surface 20s of the Raman scattering device 20 is illuminated with measurement light L1. The detection unit 40 detects the Raman-scattered light. The Raman scattering devices 20A to 20F illustrated in FIGS. 2A to 2C and 3A to 3C can be used as the Raman scattering device 20 in the Raman spectroscopic system of FIG. 6.

In the Raman spectroscopic system 2 according to the second embodiment, in order to perform microscopic observation of the sample S, an objective lens 71 is arranged above the sample cell 10 in such a manner that the objective lens 71 can relatively move in the x-y plane and in the z direction.

The illumination optical system 30 is constituted by the light source 31 and an optical splitter 32. The light source 31 emits, for example, laser light, and the optical splitter 32 leads the measurement light L1 toward the objective lens 71 and the sample cell 10, and leads detection light L2 (including reflected light and scattered light which are produced at the sample-contact surface 20s of the Raman scattering device 20 when the sample-contact surface 20s is illuminated with the measurement light L1) to the detection unit 40. Although not shown, the illumination optical system 30 may further comprise a light-guiding optical system in the optical path of the measurement light L1, when necessary. The light-guiding optical system is constituted by, for example, one or more mirrors, one or more lenses, and the like.

The detection unit 40 is a spectroscopic detector which receives the detection light L2 from the Raman scattering device 20, separates the detection light L2 into spectral components, detects the Raman-scattered light from the detection light L2, and obtains a Raman spectrum. Although not shown, a microscopic image monitor for the sample S is provided with the detection unit 40 in the microscopic Raman spectroscopic system 2.

Similar to the first embodiment, the sample cell 10 is a boxlike cell, and the electrode 21 of the Raman scattering device 20 is fit in the bottom plate 11 of the sample cell 10.

In addition, a voltage application unit 50 is provided with the sample cell 10, and applies an electric voltage to the sample S so as to bring the one or more materials to be measured close to the sample-contact surface 20s of the Raman scattering device 20 by electrophoresis. However, unlike the first embodiment, counter electrodes 51 are obliquely arranged in the sample cell 10 on both sides of the optical path between the objective lens 71 and the Raman scattering device 20 in such a manner that each of the counter electrodes 51 diagonally faces the Raman scattering device 20.

Since the Raman spectroscopic system 2 according to the second embodiment has the above construction, the Raman spectroscopic system 2 can perform measurement in a similar manner to the first embodiment except that it is possible to microscopically observe the sample S during the measurement. That is, the present invention can be applied to the microscopic Raman spectroscopic system, and the Raman spectroscopic system 2 according to the second embodiment has similar advantages to the first embodiment.

What is claimed is:

1. A Raman spectroscopic system comprising:
a sample cell in which a sample is filled or through which the sample flows down, where the sample has fluidity and contains one or more materials being to be measured, and having an electrophoretic feature or being conditioned in advance so as to have an electrophoretic feature;
a Raman scattering device which has a sample-contact surface, and outputs Raman-scattered light when the sample-contact surface is illuminated with measurement light, where the Raman scattering device is arranged in such a manner that said sample is in contact with the sample-contact surface;
an optical system which illuminates with said measurement light said sample in contact with said sample-contact surface;
a voltage application unit which is provided with said sample cell and applies an electric voltage to said sample so as to bring said one or more materials close to said sample-contact surface by electrophoresis; and
a detection unit which detects said Raman-scattered light.

2. A Raman spectroscopic system according to claim 1, wherein said Raman scattering device comprises a first electrode, a dielectric body formed above the first electrode, and a metal body being arranged above the dielectric body and in contact with said sample and causing surface-enhanced Raman scattering, and said voltage application unit is realized by said first electrode and a second electrode arranged opposite to said Raman scattering device in such a manner that at least a portion of said sample exists between the second electrode and the Raman scattering device.

3. A Raman spectroscopic system according to claim 1, wherein said Raman scattering device comprises a metal body being arranged in contact with said sample, causing surface-enhanced Raman scattering, and behaving as a first electrode, and said voltage application unit is realized by said first electrode and a second electrode arranged opposite to said Raman scattering device in such a manner that at least a portion of said sample exists between the second electrode and the Raman scattering device.

4. A Raman spectroscopic system according to claim 2, wherein said metal body has a structure of protrusions and recessions which is finer than the wavelength of said measurement light.

5. A Raman spectroscopic system according to claim 3, wherein said metal body has a structure of protrusions and recessions which is finer than the wavelength of said measurement light.

6. A Raman spectroscopic system according to claim 2, wherein said metal body contains as at least one main component at least one of the metals Au, Ag, Cu, Al, Pt, Ni, and Ti and alloys of two or more of the metals Au, Ag, Cu, Al, Pt, Ni, and Ti.

7. A Raman spectroscopic system according to claim 3, wherein said metal body contains as at least one main component at least one of the metals Au, Ag, Cu, Al, Pt, Ni, and Ti and alloys of two or more of the metals Au, Ag, Cu, Al, Pt, Ni, and Ti.

8. A Raman spectroscopic system according to claim 2, wherein said sample cell has a capillarylike form with first and second ends, the first end is in contact with said sample-contact surface, and the second end is in contact with said second electrode.

9. A Raman spectroscopic system according to claim 3, wherein said sample cell has a capillarylike form with first and second ends, the first end is in contact with said sample-contact surface, and the second end is in contact with said second electrode.

10. A Raman spectroscopic system according to claim 1, wherein said sample-contact surface is surface modified so that said one or more materials can be ionic bonded to the surface-modified sample-contact surface.

11. A Raman spectroscopic system according to claim 10, wherein said one or more materials are one or more of proteins, peptides, and amino acids, and surface modification of said sample-contact surface has at least one of the carboxyl group, the sulfonic acid group, the phosphoric acid group, the amino group, the quaternary ammonium group, the imidazole group, and the guanidium group.

12. A Raman spectroscopic system according to claim 1, wherein said sample-contact surface is surface modified so that said one or more materials can be covalently bonded to the surface-modified sample-contact surface.

13. A Raman spectroscopic system according to claim 12, wherein said one or more materials are one or more of proteins, peptides, and amino acids, and surface modification of said sample-contact surface has at least one of the reactive ester groups, the hydrazide group, the thiol group, and the reactive disulfide groups.

14. A Raman spectroscopic method comprising the steps of:
(a) preparing a sample having fluidity and containing one or more materials which are to be measured, and have an electrophoretic feature or are conditioned in advance so as to have an electrophoretic feature;
(b) placing said sample in contact with a sample-contact surface of a Raman scattering device, which outputs Raman-scattered light when the sample-contact surface is illuminated with measurement light;
(c) applying an electric voltage to said sample while maintaining the sample in contact with the sample-contact surface so as to bring the one or more materials close to the sample-contact surface by electrophoresis; and
(d) illuminating said sample with said measurement light when said one or more materials exist near said sample-contact surface, and detecting said Raman-scattered light.

15. A Raman spectroscopic method according to claim 14, wherein said sample-contact surface is surface modified so that said one or more materials brought close to the surface-modified sample-contact surface can be covalently bonded or ionic bonded to the surface-modified sample-contact surface, and said Raman-scattered light is detected in step (d) after the one or more materials brought close to the surface-modified sample-contact surface are covalently bonded or ionic bonded to the surface-modified sample-contact surface.

16. A Raman spectroscopic method according to claim 15, wherein said Raman-scattered light is detected after application of said electric voltage to said sample is stopped after said one or more materials brought close to said surface-modified sample-contact surface are covalently bonded or ionic bonded to the surface-modified sample-contact surface.

17. A Raman spectroscopic method according to claim 16, said Raman-scattered light is detected after impurities included in the sample are removed after said one or more materials brought close to said surface-modified sample-contact surface are covalently bonded or ionic bonded to the surface-modified sample-contact surface.

18. A Raman spectroscopic method comprising the steps of:
(a) preparing a sample having fluidity and containing one or more materials which are to be measured and have an amphoteric feature;
(b) conditioning the hydrogen ion concentration of said sample so that said one or more materials are positively or negatively charged;
(c) placing said sample in contact with a sample-contact surface of a Raman scattering device, which outputs Raman-scattered light when the sample-contact surface is illuminated with measurement light;
(d) applying an electric voltage to said sample while maintaining the sample in contact with the sample-contact surface so as to bring the one or more materials close to the sample-contact surface by electrophoresis; and
(e) illuminating said sample with said measurement light when said one or more materials exist near said sample-contact surface, and detecting said Raman-scattered light.

19. A Raman spectroscopic method according to claim 18, wherein said sample-contact surface is surface modified so that said one or more materials brought close to the surface-modified sample-contact surface can be covalently bonded or ionic bonded to the surface-modified sample-contact surface, and said Raman-scattered light is detected in step (e) after the one or more materials brought close to the surface-modified sample-contact surface are covalently bonded or ionic bonded to the surface-modified sample-contact surface.

20. A Raman spectroscopic method according to claim 19, wherein said Raman-scattered light is detected after application of said electric voltage to said sample is stopped after said one or more materials brought close to said surface-modified sample-contact surface are covalently bonded or ionic bonded to the surface-modified sample-contact surface.

21. A Raman spectroscopic method according to claim 20, wherein said Raman-scattered light is detected after impurities included in the sample are removed after said one or more materials brought close to said surface-modified sample-contact surface are covalently bonded or ionic bonded to the surface-modified sample-contact surface.
